(19) United States
(12) Patent Application Publication
(10) Pub. No.: US 2013/0121241 A1
(43) Pub. Date: May 16, 2013

(54) Indication of Selected Core Network in a Network Sharing Environment

(71) Applicant: Guillaume SEBIRE, Espoo (FI)

(72) Inventor: Guillaume SEBIRE, Espoo (FI)

(73) Assignee: Renesas Mobile Corporation

(21) Appl. No.: 13/300,072

(22) Filed: Nov. 18, 2011

(30) Foreign Application Priority Data
Nov. 16, 2011 (GB) 1119777.9

(51) Int. Cl. H04W 8/02

(52) U.S. Cl. 370/328

(57) ABSTRACT

A network broadcasts a list of multiple core networks. A mobile station MS selects one and sends an uplink message (e.g., ATTACH or ROUTING AREA UPDATE Request) with a new format detailed by these teachings. The body of the message has a data section and an identity section, and the identity section includes: a temporary identifier for a mobile station, a bit sequence indicating that a selected core network is identified in the uplink message and indicating type for the temporary identifier (e.g., Foreign or Random TLLI), and an indication of the selected core network. For the Foreign TLLI there is an extension field for the additional bits of the Foreign TLLI as compared to the Random TLLI, and the Foreign TLLI is derived from the mobile station's PTMSI.

### CROSS REFERENCE TO RELATED APPLICATION

This application claims benefit under 35 U.S.C. §119(a) and 37 CFR 1.55 to UK Patent Application 1119777.9, filed on Nov. 16, 2011.

### TECHNICAL FIELD

The exemplary and non-limiting embodiments of this invention relate generally to wireless communication systems, methods, devices and computer programs and, more specifically, relate to communicating between a mobile station and a base station which of several core networks the mobile station has selected. In the particular non-limiting examples presented herein the mobile station informs a GERAN BSS which PLMN it has selected.

### BACKGROUND

The following abbreviations that may be found in the specification and/or the drawing figures are defined as follows:

3GPP third generation partnership project

BSS base service station

CS circuit switched

EDGE Enhanced Data rates for GSM/Global Evolution

EGPRS enhanced GPRS (used by GERANs)

GERAN GSM/EDGE radio access network (uses EGPRS)

GMM GPRS mobility management

GPRS general packet radio service

GRNTI GERAN radio network temporary identifier

GSM global system for mobile communications

ID identifier

IMSI international mobile subscriber identity

LLC link layer control

MAC medium access control

MCC mobile country code

MNC mobile network code

MOCN multiple operator core network

MS mobile station

PLMN public land mobile network

PTMSI packet temporary mobile subscriber identity

RLC radio link control

RR radio resource

SGSN serving GPRS support node

TBF temporary block flow

TLLI temporary logical link identity

In certain wireless networks the access node is connected to several different core networks. When a mobile station attaches to such an access node it is advantageous to indicate which of those core networks the mobile station is to be registered so the access node can contact the correct one. While the examples below are in the context of the 3G system (specifically the GERAN version of it) for solving a problem that persists in that regard, the broader teachings herein are not limited only to the GERAN system.

In GERAN the core networks are represented by their operators, the PLMNs. As shown in FIG. 1 a single BSS may have a Gb interface to multiple PLMNs. The BSS must be able to route uplink data from a MS to the appropriate core network (and vice versa in the downlink direction) in order to properly route the MS's uplink traffic. These teachings solve the problem of how the MS can indicate the PLMN it selects to the BSS in the packet switched domain (GPRS) in the access stratum, shown in FIG. 1 as the Um interface.

Document C1-114449 entitled “REPLY LS ON THE INTRODUCTION OF FULL-MOCN-GERAN FEATURE” (3GPP TSG CT WG1 Meeting #74; Hyderabad, India; 10-14 Oct. 2011) sets forth that the relevant instances to address for the uplink direction include the MS's ATTACH REQUEST and the ROUTING AREA UPDATE REQUEST messages, which are when the MS uses a foreign TLLI or a random TLLI (detailed further below). As set forth in 3GPP TS 44.060 v10.6.0 (specifically, §§10.2.2 and 10.3a.2 which define the uplink GPRS RLC data block and the uplink EGPRS RLC data block), the TLLI is used in the RLC/MAC protocol on the Um interface and in the BSSGP protocol on the Gb interface to identify a specific MS.

The MS's ATTACH REQUEST and [GMM] ROUTING AREA UPDATE REQUEST messages must of course pass over the Um interface to the BSS before passing over the Gb interface to any SGSN. To this end, the RLC/MAC protocol in GERAN uses a TBF which is a layer 2 link established between a MS and the BSS. While a TBF can be either uplink or downlink, the uplink TBF is relevant for this example in which the MS sends data to the network. In a full MOCN network as shown at FIG. 1, the GERAN BSS controlling a shared cell broadcasts a list of the PLMNs sharing the cell which provides the PLMN identities (MCC and MNC) to the MSs in the cell that are able to decode them, so the MS of FIG. 1 will be aware that the BSS is connected to multiple PLMNs.

The GERAN system provides the following procedures which are relevant for the ATTACH and ROUTING AREA UPDATE requests. In A/Gb mode, while a packet TMSI (P-TMSI) is used in the GMM sublayer for identification of an MS, a TLLI is used for addressing purposes at the RR sublayer. 3GPP TS 23.003 v10.3.0, §§2.6 and 2.7 define the TLLI and the PTMSI respectively and show detailed coding of the different TLLI types and how a TLLI can be derived from a P-TMSI. But in the FIG. 1 scenario assume the MS is not yet attached to the BSS or needs to update its routing area (for example, the MS is in IDLE or some other mode other than ATTACHED). If this is due to mobility from another BSS the MS may have a valid PTMSI and so will follow option i) below and use a foreign TLLI, and if the MS is just powering on it has no valid PTMSI it will follow option ii) below and use a random TLLI.

The TLLI is used to identify a specific MS. TLLI assignment is controlled by GMM. TLLI is not carried in LLC frames, but in BSSGP messages as defined in 3GPP TS 48.018 v10.4.0, and in RLC/MAC blocks as defined in 3GPP TS 44.060 v10.6.0. 3GPP TS 24.008 v11.0.0 specifies the “AttachWithIMSI” procedure quoted below.
§4.7.1.4.1
If the MS is configured for “AttachWithIMSI” and is entering a new PLMN which is neither the registered PLMN nor in the list of equivalent PLMNs, the MS should proceed as specified for case ii) below and use a randomly selected random TLLI for the transmission of the ATTACH REQUEST message.
For all other cases, the MS shall determine the TLLI as follows:
For an MS not supporting S1 mode, two cases can be distinguished:
   a valid P-TMSI is available in the MS; or
   no valid P-TMSI is available in the MS.
i) valid P-TMSI available
   If the MS has stored a valid P-TMSI, the MS shall derive a foreign TLLI from that P-TMSI and shall use it for transmission of the:
      ATTACH REQUEST message of any GPRS combined/non-combined attach procedure; other GMM messages sent during this procedure shall be transmitted using the same foreign TLLI until the ATTACH ACCEPT message or the ATTACH REJECT message is received; and
      ROUTING AREA UPDATE REQUEST message of a combined/non-combined RAU procedure if the MS has entered a new routing area, or if the GPRS update status is not equal to GU1 UPDATED. Other GMM messages sent during this procedure shall be transmitted using the same foreign TLLI, until the ROUTING AREA UPDATE ACCEPT message or the ROUTING AREA UPDATE REJECT message is received.
   After a successful GPRS attach or routing area update procedure, independent of whether a new P-TMSI is assigned, if the MS has stored a valid P-TMSI then the MS shall derive a local TLLI from the stored P-TMSI and shall use it for addressing at lower layers.
   NOTE 1: Although the MS derives a local TLLI for addressing at lower layers, the network should not assume that it will receive only LLC frames using a local TLLI. Immediately after the successful GPRS attach or routing area update procedure, the network must be prepared to continue accepting LLC frames from the MS still using the foreign TLLI.
ii) no valid P-TMSI available
   When the MS has not stored a valid P-TMSI, i.e. the MS is not attached to GPRS, the MS shall use a randomly selected random TLLI for transmission of the:
      ATTACH REQUEST message of any combined/non-combined GPRS attach procedure.
   The same randomly selected random TLLI value shall be used for all message retransmission attempts and for the cell updates within one attach attempt. Upon receipt of an ATTACH REQUEST message, the network shall assign a P-TMSI to the MS. The network derives a local TLLI from the assigned P-TMSI, and transmits the assigned P-TMSI to the MS.
   Upon receipt of the assigned P-TMSI, the MS shall derive the local TLLI from this P-TMSI and shall use it for addressing at lower layers.
   NOTE 2: Although the MS derives a local TLLI for addressing at lower layers, the network should not assume that it will receive only LLC frames using a local TLLI. Immediately after the successful GPRS attach, the network must be prepared to continue accepting LLC frames from the MS still using the random TLLI.

Note that in both cases, there is no local TLLI until after the ATTACH or ROUTING AREA UPDATE requests are sent by the MS; in each case those requests are sent with a foreign or a random TLLI, and the BSS does not know from receiving either of those requests which PLMN is the appropriate one for this MS.

The above referenced document C1-114449 suggests how the MS might identify one PLMN from the group the BSS identifies in its broadcast list: “to include the PLMN identity (or PLMN Id Index, e.g. similar to the usage of Skip Indicator solution in the CS domain) in the data block (outside of LLC frame), and indicate the inclusion of the PLMN identity (or PLMN Id Index) by using 1 spare bit in the RLC/MAC header”. The PLMN ID Index referred to in this quote is an index into the same list of PLMN IDs that are broadcast in the shared cell. So for example if the maximum number of PLMN IDs that can be broadcast in a cell is five, the index will consist of three bits such that the first index (value 000) points to the first PLMN ID in the list and so on. For convenience, the specific one of these indices that the MS is to signal over the Um interface is termed in these teachings as the selected PLMN index.

Document C1-114449 provides that the spare bit from the RLC/MAC header identifies whether a selected PLMN index is included, and the actual selected PLMN index is in the data block that the MS sends uplink. But that spare bit is the last spare bit in the header of the GPRS blocks and of the EGPRS blocks with type 3 headers, leaving no room for manifesting future improvements for those data blocks in the header. And since there are two spare bits remaining in EPGRS data blocks with other types of headers, utilizing the spare header bit in the two data blocks above is seen to make reasonable use of those remaining header bits more difficult in practice which would also constrain future improvements. This is particularly true when the only spare header bit is used for what is expected to be a relatively rare signaling event, in this case indicting presence of a PLMN index.

An alternative approach would be the definition of a seven-bit extension field for which three bits are used to indicate the selected PLMN index and an extension indicator IE bit is used to indicate whether or not there is a selected PLMN index provided there. While this does allow a bit more flexibility, it imposes on the BSS different handling of the PLMN index depending on what types of blocks and headers are sent. These teachings provide a different way of signaling which preserves the valuable spare header bit for a more suitable future purpose and which is a more uniform signaling architecture for the BSS and MS.

### SUMMARY

The foregoing and other problems are overcome, and other advantages are realized, by the use of the exemplary embodiments of this invention.

In a first exemplary embodiment of the invention there is an apparatus comprising at least one processor and at least one memory storing a computer program. In this embodiment the at least one memory with the computer program is configured with the at least one processor to cause the apparatus to at least: select a core network from a broadcast list identifying multiple core networks; and send an uplink message comprising a header and a body, the body comprising a data section and an identity section, in which the identity section comprises a temporary identifier for a mobile station, a bit sequence indicating that a selected core network is identified in the uplink message and indicating type for the temporary identifier, and an indication of the selected core network.

In a second exemplary embodiment of the invention there is a method comprising: selecting a core network from a broadcast list identifying multiple core networks; and sending an uplink message comprising a header and a body, the body comprising a data section and an identity section, in which the identity section comprises a temporary identifier for a mobile station, a bit sequence indicating that a selected core network is identified in the uplink message and indicating type for the temporary identifier, and an indication of the selected core network.

In a third exemplary embodiment of the invention there is a computer readable memory tangibly storing a computer program executable by at least one processor, the computer program comprising: code for selecting a core network from a broadcast list identifying multiple core networks; and code for sending an uplink message comprising a header and a body, the body comprising a data section and an identity section, in which the identity section comprises a temporary identifier for a mobile station, a bit sequence indicating that a selected core network is identified in the uplink message and indicating type for the temporary identifier, and an indication of the selected core network.

In a fourth exemplary embodiment of the invention there is an apparatus comprising at least one processor and at least one memory storing a computer program. In this embodiment the at least one memory with the computer program is configured with the at least one processor to cause the apparatus to at least: receive an uplink message comprising a header and a body, the body comprising a data section and an identity section, in which the identity section comprises a temporary identifier for a mobile station, a bit sequence indicating that a selected core network is identified in the uplink message and indicating type for the temporary identifier, and an indication of the selected core network; determine from the received uplink message which one among multiple core networks listed in a broadcast message is selected by the mobile station, and send a second message comprising at least the data section of the uplink message to the selected core network.

In a fifth exemplary embodiment of the invention there is a method comprising: receiving an uplink message comprising a header and a body, the body comprising a data section and an identity section, in which the identity section comprises a temporary identifier for a mobile station, a bit sequence indicating that a selected core network is identified in the uplink message and indicating type for the temporary identifier, and an indication of the selected core network; determining from the received uplink message which one among multiple core networks listed in a broadcast message is selected by the mobile station, and sending a second message comprising at least the data section of the uplink message to the selected core network.

In a sixth exemplary embodiment of the invention there is a computer readable memory tangibly storing a computer program executable by at least one processor, the computer program comprising: code for receiving an uplink message comprising a header and a body, the body comprising a data section and an identity section, in which the identity section comprises a temporary identifier for a mobile station, a bit sequence indicating that a selected core network is identified in the uplink message and indicating type for the temporary identifier, and an indication of the selected core network; code for determining from the received uplink message which one among multiple core networks listed in a broadcast message is selected by the mobile station; and code for sending a second message comprising at least the data section of the uplink message to the selected core network.

### BRIEF DESCRIPTION OF THE DRAWINGS

FIG. 1 is a high level prior art schematic diagram showing a GERAN BSS interfacing three PLMNs over distinct Gb interfaces and a MS over a Um interface and is an exemplary environment in which embodiments of these teachings may be practiced to advantage.

FIG. 2A is a GPRS uplink RLC data block with MAC header for data transfer, and is reproduced from FIG. 10.2.2.1 of 3GPP TS 44.060 v10.6.0.

FIG. 2B is an EPGRS RLC block for data transfer, and is reproduced from figure 10.3a.2.1 of 3GPP TS 44.060 v10.6.0.

FIG. 2C illustrates the structure for conventional TLLIs and is reproduced from table 1 at section 2.6 of 3GPP TS 23.003 v10.3.0.

FIG. 3 is a table showing bit positions for fields shown at FIG. 4A-B which carry the various indications concerning signaling a selected PLMN according to exemplary embodiments of these teachings.

FIG. 4A is similar to FIG. 2A but adapted to include new fields according to an exemplary embodiment of these teachings.

FIG. 4B is similar to FIG. 2B but adapted to include new fields according to an exemplary embodiment of these teachings.

FIG. 5A illustrates conceptually the relation between the conventional Foreign TLLI formats of FIGS. 2A-B and the new formats according to these teachings which are illustrated at FIGS. 4A-B.

FIG. 5B is similar to FIG. 5A but for the Random TLLI formats.

FIG. 6A-B are each logic flow diagrams that illustrates from the perspective of the MS and the BSS respectively the operation of a method, and a result of execution of computer program instructions embodied on a computer readable memory, in accordance with exemplary embodiments of these teachings.

FIG. 7 is a simplified block diagram showing the MS and the BSS of FIG. 1, which are exemplary electronic devices suitable for use in practicing the exemplary embodiments of this invention.

### DETAILED DESCRIPTION

As detailed for FIG. 1 for the examples below assume there is a MS operating in a GERAN cell that is shared among several PLMNs, and the BSS of the cell broadcasts a list of the PLMN IDs. As is detailed with particularity below, embodiments of these teachings provide new TLLI formats for foreign TLLI and random TLLI which indicate the presence of an indication of the selected PLMN (e.g. selected PLMN index) provided by the MS in these same uplink RLC/MAC blocks. The MS can use these new formats in these uplink RLC/MAC blocks sent to the BSS on the Um interface during the establishment of an uplink TBF between the MS and the BSS. The new TLLI format for a foreign TLLI provides a TLLI extension to allow the MS to send all the bits required from the P-TMSI for a foreign TLLI.

From the BSS perspective, upon reception of an RLC/MAC block from a MS the BSS will decode the TLLI field if present, detect a new TLLI format for foreign or random TLLI, and if there is an indication that a selected PLMN index is present (and in case of a foreign TLLI, also the TLLI extension) the BSS will decode the foreign or random TLLI as well as the indication of the Selected PLMN. Based on the information received, the BSS will then select the appropriate SGSN node to contact according to the indicated selected PLMN (by means of the indicated Selected PLMN index), and will make a direct translation between the new foreign TLLI format (including the TLLI extension) and the existing foreign TLLI format or between the new random TLLI format and the existing random TLLI format in order to use the existing TLLI formats on the Gb interface.

The MS in IDLE mode and having a [GMM] ATTACH REQUEST message or a [GMM] ROUTING AREA UPDATE REQUEST message to send to the network will indicate to the BSS, during uplink TBF establishment on the Um interface, the PLMN it has selected. As detailed from the GERAN specifications in the background section above, the existing requirements for a MS having one of those messages to send must use a foreign TLLI if the MS has a valid PTMSI or a random TLLI if the MS does not have a valid PTMSI.

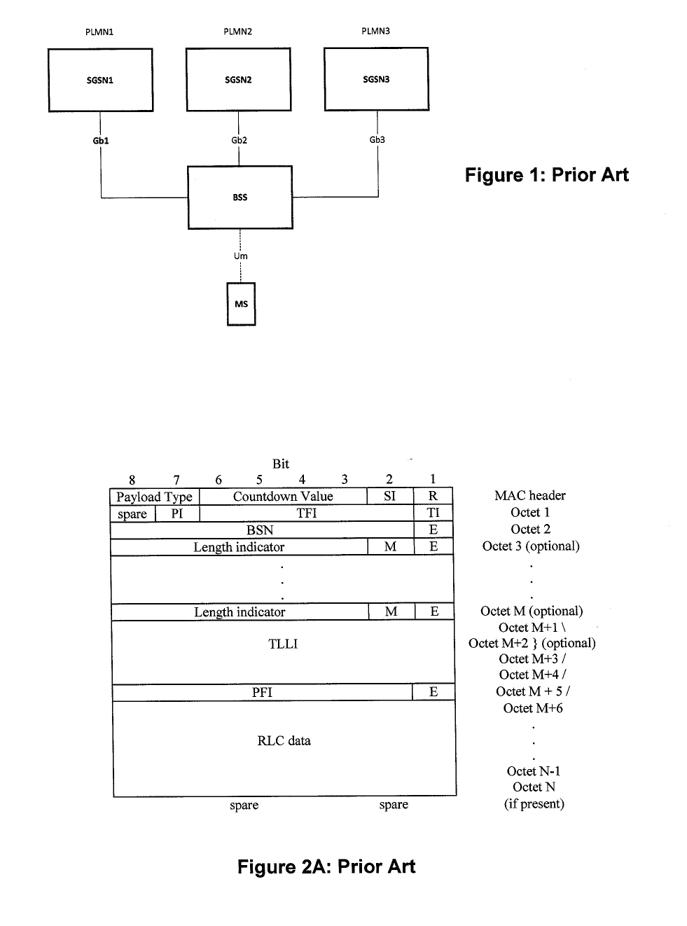

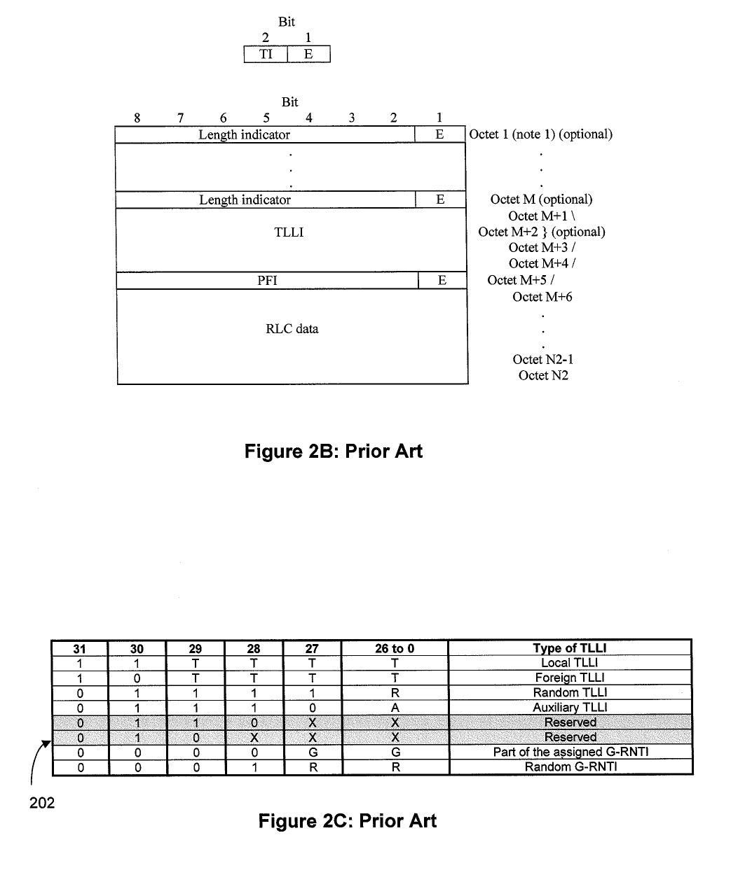

To better illustrate the distinction of these teachings first are detailed the existing GPRS procedures. During uplink TBF establishment, the MS sends RLC/MAC blocks in the uplink direction to the BSS. FIG. 2A shows a GPRS RLC/MAC block for data transfer reproduced from figure 10.2.2.1 of 3GPP TS 44.060 v10.6.0. For the uplink RLC data block with MAC header of FIG. 2A, section 10.0b.3.1 of 3GPP TS 44.060 v10.6.0 stipulates that the field mapping convention for GPRS applies, meaning that in particular regarding the TLLI field, the most significant byte of the TLLI value shall be mapped on octet M+1 and the least significant byte of the TLLI value shall be mapped on octet M+4 of the uplink RLC data block.

FIG. 2B shows an EPGRS RLC block for data transfer reproduced from figure 10.3a.2.1 of 3GPP TS 44.060 v10.6.0. For the uplink EGPRS data block of FIG. 2B, Annex J of that technical standard provides an example by which “Octet 1” shall be replaced by “Octet 7” if padding bits are used. Section 10.0b.3.2 of that same technical standard provides that the field mapping convention for EGPRS applies, meaning that in particular regarding the TLLI field, the least significant byte of the TLLI value shall be mapped on octet M+1 and the most significant byte of the TLLI value shall be mapped on octet M+4 of the uplink EGPRS RLC data block.

The TLLI itself is defined in 3GPP TS 23.003 v10.3.0 at §2.6, and FIG. 2C reproduces table 1 from that section showing the various TLLI structures. In FIG. 2C, the designators ‘T’, ‘R’, ‘A’ and ‘X’ indicate bits which can take any value for the type of TLLI. More precisely, ‘T’ indicates bits derived from a P-TMSI, ‘R’ indicates bits chosen randomly, ‘A’ indicates bits chosen by the SGSN, ‘G’ indicates bits derived from the assigned G-RNTI and ‘X’ indicates bits in reserved ranges.

FIG. 2C reveals that there are two TLLI formats marked as Reserved, both of which are shaded. For convenience and for seamless adoption of these teachings with existing GPRS/EGPRS systems, in one non-limiting embodiment the conventional reserved format 202 which has bit positions 31-29 carrying respective values of “0 1 0” is used as the basis for the two new TLLI formats noted above, the new format for the foreign TLLI and for the random TLLI. As further noted above, these new formats will also indicate the presence of an indication of the selected PLMN (the selected PLMN index) in the RLC/MAC block.

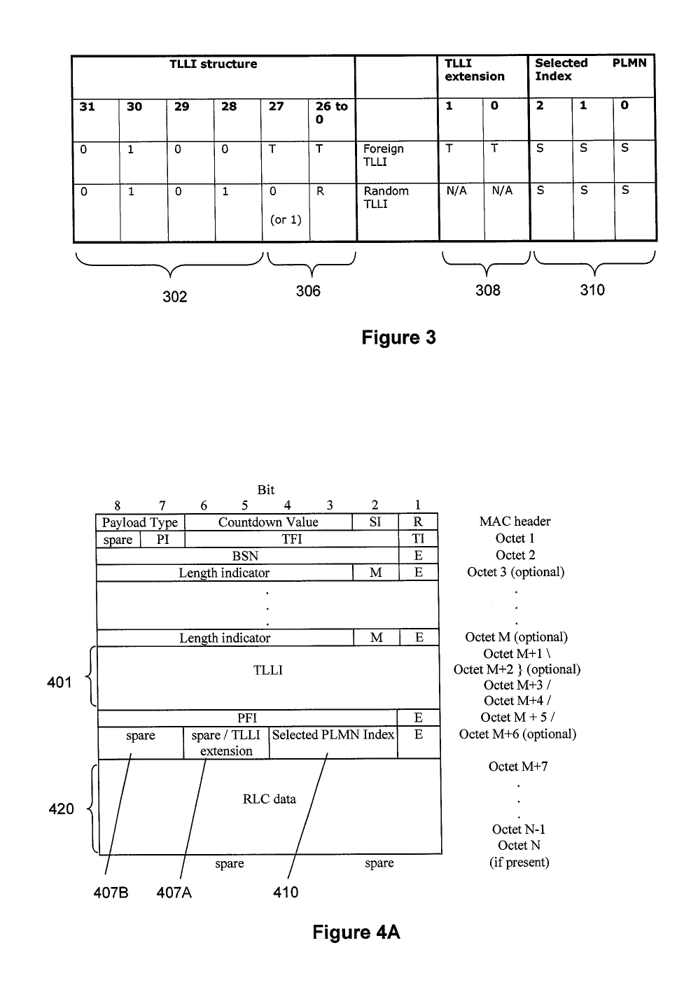

Note that in conventional GPRS, 3GPP 23.003 v10.3.0 requires at sections 2.6 and 2.7 that a foreign TLLI must contain 30 bits of the P-TMSI (specifically bits 29 to 0 of the P-TMSI). Therefore and with reference to FIG. 3, according to this specific embodiment the new TLLI formats are defined as follows:
Bits 31-28 of the TLLI set to “0 1 0 0” or Bits 31-27 of the TLLI set to “0 1 0 1 0” indicate the presence of the indication of the selected PLMN (that is, the selected PLMN index) in the RLC/MAC block in which the TLLI field is included; and
Bits 31-28 of the TLLI set to “0 1 0 0” further indicates a Foreign TLLI is used; and
   In this case Bits 27-0 of the TLLI field (reference number 306) contain Bits 29-2 of the P-TMSI; and
   A TLLI Extension (reference number 308) in the same RLC/MAC block where the bits 1-0 of this TLLI Extension contain bits 1-0 of the P-TMSI
Bits 31-27 of the TLLI set to “0 1 0 1 0” further indicates a Random TLLI is used; and
   In this cases Bits 26-0 of the TLLI field (reference number 306) are chosen randomly;
The Indication of the Selected PLMN (reference number 310) contains e.g. the selected PLMN index (here shown as being three bits “S S 5”).

For the Foreign TTLI there is a length-4 format and type bit sequence 302 (value 0 1 0 0) as illustrated at FIG. 3 which indicates the new format (in which the new format in itself indicates that there is present in this message a selected PLMN index 310) and which also indicates the identifier type (Foreign TLLI). In this case the actual identifier for the MS (the TLLI derived from the MS's PTMSI) spans fields 306 and 308 of FIG. 3, where field 306 includes bit #27 as shown at FIG. 3.

For the Random TLLI the division between fields 302 and 306 is slightly different from that particularly shown at FIG. 3. In this case the format and type bit sequence 302 is length-5 (value 0 1 0 1 0, or in another embodiment value 0 1 0 1 1) with the extra bit for sequence 302 taken from field 306 which spans only bit numbers 26 through 0. Both Foreign TLLI and Random TLLI formats include a selected PLMN in that same data block/message, so each of these formats themselves indicate that the data block identifies a selected PLMN.

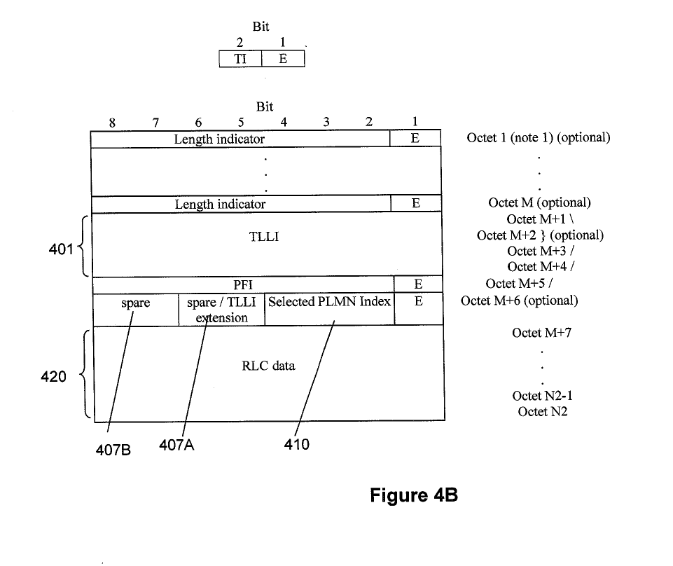

The above new TLLI formats would be disposed in the GPRS uplink RLC/MAC block for data transfer, which is conventionally shown at FIG. 2A, as shown at the new GPRS uplink RLC/MAC block for data transfer shown at FIG. 4A. The values for TLLI structure bits 31 through 0 remain in field 401 of the data block but with the values described for reference numbers 302 and 306 of FIG. 3. The two bits used for the TLLI extension in the case of a foreign TLLI, shown at field 308 of FIG. 3, will be in a portion 407A of the spare bits field leaving remaining portion 407B available for future use. If one considers the TTLI field 401 as an identity section (and the RLC data section 420 as a data section), the fact that the extension field 407A might not be sequential with the other bits of the TLLI octets does not exclude it from the identity section because at least for the foreign TLLI case that extension section is used to identify the MS. For the case of a random TLLI format both these portions 407A and 407B remain available for other uses. And the three bits for the selected PLMN index shown in FIG. 3 by reference number 310 are disposed in field 410 of FIG. 4A having the same name. The added octet bearing the fields 407B, 407A and 410 at FIG. 4A does not necessarily reduce the maximum payload size for the RLC data in this example, since there is an added Octet M+7 at FIG. 4A which is optional.

The above new TLLI formats would also be disposed in the EGPRS uplink RLC data block, which is conventionally shown at FIG. 2B, as illustrated for the new EGPRS uplink RLC data block of FIG. 4B. Like FIG. 4A, at FIG. 4B the values for TLLI structure bits 31-0 remain in field 401 but with the values described for reference numbers 302 and 306 of FIG. 3. The two bits used for the TLLI extension in the case of a foreign TLLI, shown at reference number 308 of FIG. 3, will be in a portion 407A of the spare bits field leaving remaining portion 407B available for future use. For the case of a random TLLI format both these portions 407A and 407B remain available for other uses. And the three bits for the selected PLMN index shown in FIG. 3 by reference number 310 are again disposed in field 410 of FIG. 4B having the same name. The added octet bearing the fields 407B, 407A and 410 at FIG. 4B is similarly added as Octet M+7.

As noted above, these new TLLI formats detailed herein for the Foreign and Random TLLIs are for use on the Um interface with RLC data blocks. For RLC/MAC control messages that require a TLLI, such as for example control messages exchanged during contention resolution, the conventional TLLI format shown at FIG. 2C should still be used i.e. including the conventional TLLI format for the Foreign and Random TLLIs. Between the BSS and the PLMN on the Gb interface, the existing formats must be used and so these teachings leave the conventional BSSGP protocol on the Gb interface unaffected meaning embodiments of these teachings are simpler to incorporate into existing GPRS/EGPRS infrastructure.

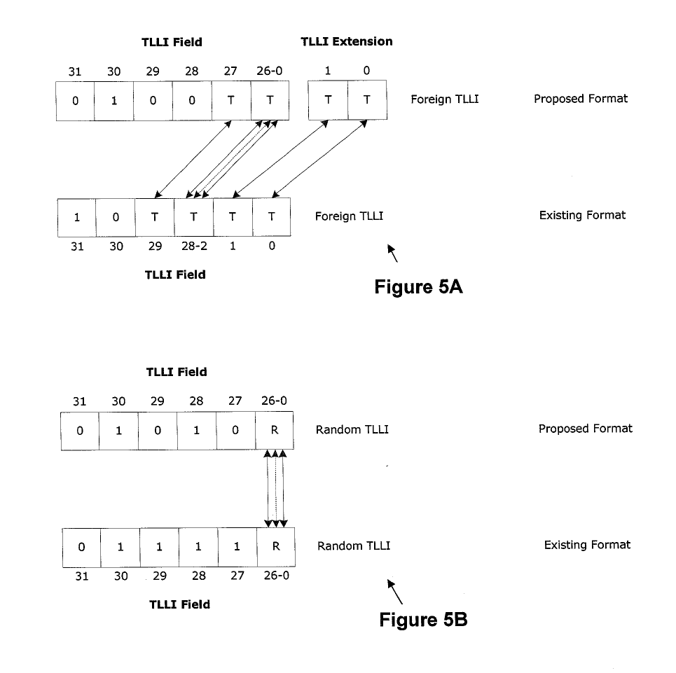

FIGS. 5A-B illustrate conceptually the relation between the conventional formats and those detailed at FIGS. 4A and 4B. Specifically, FIG. 5A illustrates the relation concerning the Foreign TLLI formats and FIG. 5B illustrates the relation concerning the Random TLLI formats.

The relation between the proposed formats and the existing formats is illustrated below. A direct translation is made between the proposed Foreign TLLI format (including the “T” bits in the TLLI Extension) and the existing Foreign TLLI format and between the proposed Random TLLI format and the existing Random TLLI format; the “T” bits of the new format detailed herein, which the MS derives from its valid PTMSI, are used as the “T” bits in the conventional formats; the “R” bits of the new format detailed herein are as the “R” bits in the conventional formats.

Since in an embodiment the BSS will not change its signaling regimen over the Gb interface from what is conventional yet it is getting a new format for the data block received on the Um interface, the BSS is required to perform some translation or association between the new TLLI formats received on the Um interface and the conventional TLLI format it will send on the Gb interface. In some case such a translation might also be done in the opposite downlink direction by the MS for RLC/MAC control messages sent to the MS. For example, during contention resolution during which the BSS uniquely identifies the MS the BSS may send a conventional format to the MS even though it received one of the new formats on the uplink from it.

First consider FIG. 5A which shows the translation of the Foreign TLLI between the conventional format at the lower row and the new format in the upper row. Thirty two bits are needed for the TLLI; conventionally these are done with bits in positions 29 through 0 set to bits 29-0 of the P-TMSI and with bits in positions 31 and 30 used to indicate the Foreign TTLI format as in the second row of FIG. 2C i.e. “1, 0”. With reference to FIG. 2C and 3, bits 31 through 28 carry the value “0, 1, 0, 0” to indicate the new format for a Foreign TLLI type. The translation will be that for the TLLI field 401 itself, bit positions 27 through 0 of the new format correspond to respective bit positions 29 through 2 of the conventional format, and bit positions 1 and 0 of the TLLI extension field (407A of FIGS. 4A-B; 308 of FIG. 3) of the new format correspond to respective bit positions 1 and 0 of the TLLI field of the conventional format.

FIG. 5B is a more straightforward translation since only 27 random bits are needed for a random TLLI value and so all will be in the TLLI field 401 similar to the conventional format. The conventional random TLLI format at the lower row of FIG. 5B corresponds to the third row of FIG. 2C, with values “0, 1, 1, 1, 1” in respective bits 31 through 27 followed by bits 26 through 0 which indicate the random value of the random TLLI. For the new format at the upper row of FIG. 5B the values “0, 1, 0, 1, 0” at bits 31 through 27 indicate the new format for a Random TLLI type, and the values at bits 26 through 0 indicate the random TLLI value which correspond to the same bit positions of the conventional format.

One technical effect of certain embodiments of these teachings is that they avoid using any of the spare bits from the MAC or RLC/MAC header of the GPRS and EGPRS blocks, which is a significant advantage given the indication of the selected PLMN need only be done temporarily and in given conditions only. By these teachings the spare bits in the headers therefore remain thus available for future use. Another technical effect is that changes according to these teachings over the conventional signaling regimen affects only the Um interface, so the BSSGP protocol on the Gb interface remains unchanged and embodiments are simpler to implement in legacy infrastructure since the changes do not propagate to the core networks at all. While there is some translation between new and conventional formats that will need to be done, as shown at FIGS. 5A-B this is quite a simple task for the BSS and/or MS.

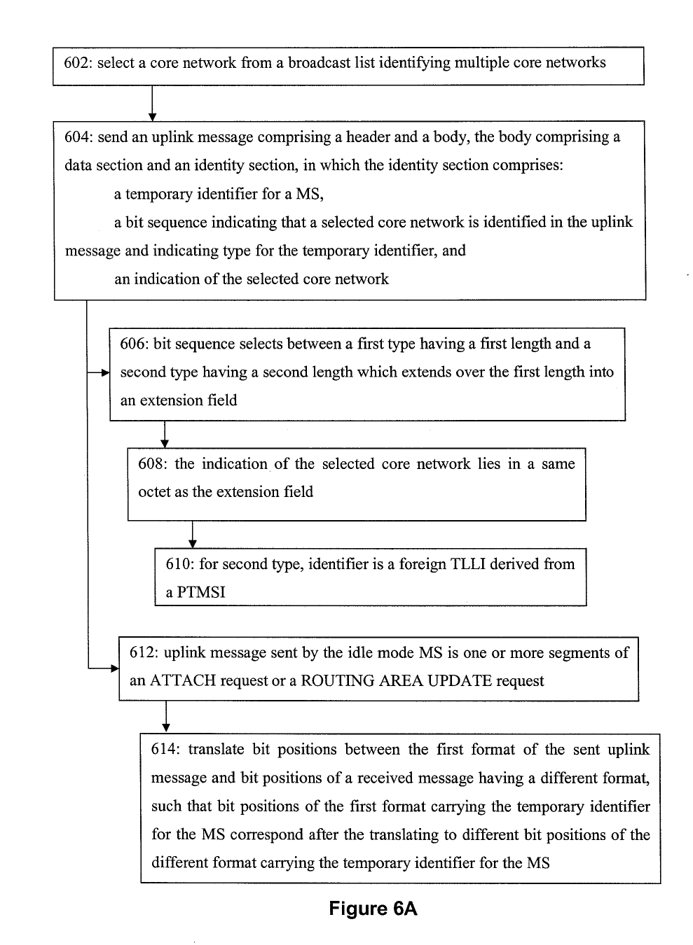

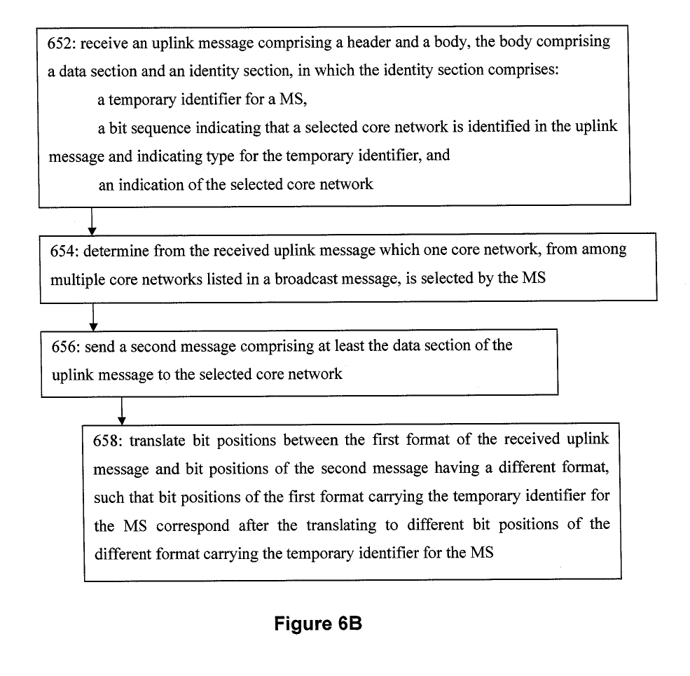

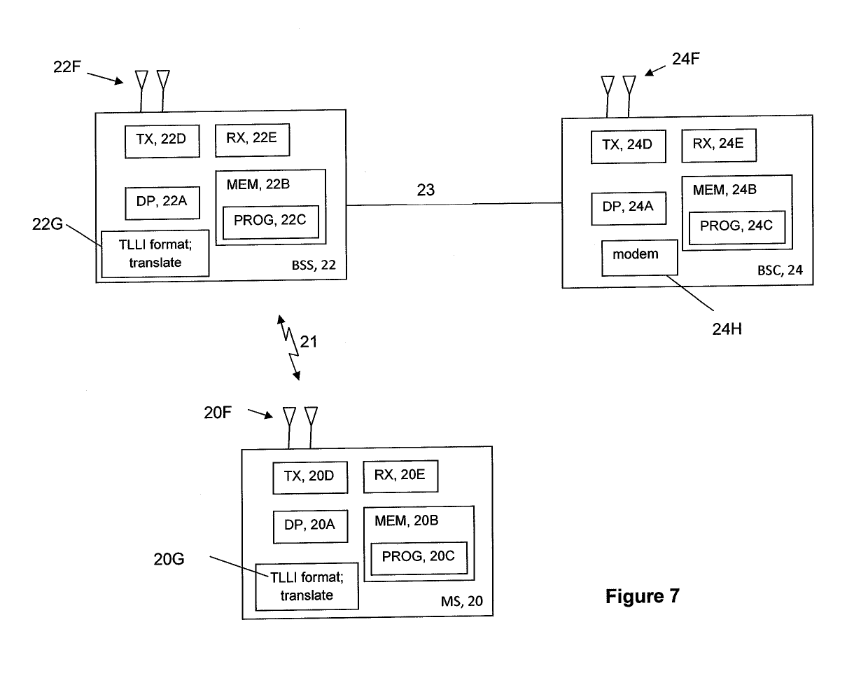

Now are detailed with reference to FIG. 6A particular exemplary embodiments from the perspective of the MS. FIG. 6A may be performed by the whole MS 20, 24 shown at FIG. 7, or by one or several components thereof such as a modem. At block 602 the MS 20 selects a core network from a broadcast list identifying multiple core networks. Then at block 604 the MS sends an uplink message comprising a header and a body, the body comprising a data section (420) and an identity section (401), in which the identity section comprises a temporary identifier for a mobile station (306), a bit sequence (302) indicating that a selected core network is identified in the uplink message and indicating type for the temporary identifier, and an indication of the selected core network (310, 410).

Further portions of FIG. 6A represent various of the specific but non-limiting embodiments detailed above. Block 606 specifies the example in which the bit sequence selects between a first type for the temporary identifier having a first length (for example, the random TLLI with 27 random bits) and a second type for the temporary identifier having a second length (for example, the foreign TLLI with 30 bits of the PTMSI) which extends over the first length into an extension field (407A). Block 608 codifies what is obvious from FIGS. 4A-B, that the indication of the selected core network (310, 410) lies in a same octet as the extension field (407A). And block 610 is specific for the foreign TLLI (the second type for the temporary identifier at block 606), namely that it is derived from the MS's valid PTMSI.

Block 612 may be employed with any of the preceding blocks of FIG. 6A, and simply gives the examples above that the uplink message sent by the idle mode MS is one or more segments of an ATTACH request or a ROUTING AREA UPDATE request (segments because these messages are at the GMM layer that sits above the RLC layer at which occurs segmentation and re-assembly of upper layer data). And finally block 614 summarizes the translating shown at FIG. 5A, namely that if we consider the bit sequence (302) of block 604 indicating a first format which identifies a selected core network (that is, the format itself indicates that there is present in this uplink message a selected bit index), the MS further translates bit positions between the first format and bit positions of a received message having a different format, such that bit positions of the first format carrying the temporary identifier for the mobile station correspond after the translating to different bit positions of the different format carrying the temporary identifier for the mobile station.

FIG. 6B summarizes some of the various embodiments from the perspective of the BSS, and may be performed by the whole BSS 22 shown at FIG. 7, or by one or several components thereof such as a modem. At block 652 the BSS receives an uplink message comprising a header and a body, the body comprising a data section (420) and an identity section (401), in which the identity section comprises a temporary identifier for a mobile station (306), a bit sequence indicating that a selected core network is identified in the uplink message and indicating type for the temporary identifier, and an indication of the selected core network (310, 410). At block 654 the MS determines from the received uplink message which one core network, from among multiple core networks listed in a broadcast message, is selected by the MS. And then at block 656 the BSS sends a second message comprising at least the data section of the uplink message to the selected core network.

Various of the similar specific but non-limiting embodiments detailed above for FIG. 6A apply equally for the BSS at FIG. 6B. However, the translating operates a bit differently for the BSS and is described at block 658. If again we consider the bit sequence of block 652 as indicting a first format in which there is present an indication of a selected core network, then the BSS at block 658 will translate bit positions between the first format and bit positions of the second message having a different format, such that bit positions of the first format carrying the temporary identifier for the mobile station correspond after the translating to different bit positions of the different format carrying the temporary identifier for the mobile station. This second message with the different format is the one which the BSS sends over the Gb interface to the selected PLMN as noted at block 656.

FIGS. 6A-B are each logic flow diagrams which may be considered to illustrate the operation of a method, and a result of execution of a computer program stored in a computer readable memory, and a specific mariner in which components of an electronic device are configured to cause that electronic device to operate. The various blocks shown in each of FIGS. 6A-B may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Reference is now made to FIG. 7 for illustrating a simplified block diagram of various electronic devices and apparatus that are suitable for use in practicing the exemplary embodiments of this invention. In FIG. 7 there is a MS 20 in the GPRS/GERAN system under a BSS 22 via wireless link 21 (the Um interface of FIG. 1) which includes a higher network node (base station controller BSC) 24 which provide connectivity with further networks such as for example the PLMNs/core networks shown at FIG. 1. There is also a data/control path 23 coupling the BSS 22 with the BSC 24 (the Gb interface of FIG. 1).

The MS 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the BSS 22 via one or more antennas 20F. While only one transmitter and receiver are shown it is understood there may be more than one. Also stored in the MEM 20B at reference number 20G are the TLLI formats including new TLLI formats according to these teachings as detailed above, and the rules/algorithm for translating bit positions between them.

The BSS 22, or more generally the network access node, also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the MS 20 via one or more antennas 22F. The TLLI formats including new TLLI formats according to these teachings as detailed above, and the rules/algorithm for translating bit positions between them, are stored in the memory 22B of the BSS 22 at unit 22G.

The BSC 24 has functionally similar capabilities as shown at blocks 24A, 24B, 24C, 24D, 24E and 24F. While not particularly illustrated for the MS 20 or BSS 22, those apparatus are also assumed to include as part of their wireless communicating means a modem similar to that shown for the BSC at 2411, and which may be inbuilt on an RF front end chip within those devices 20, 22 and which also carries the TX 20D/22D and the RX 20E/22E.

At least one of the PROGs 20C/22C in the MS 20 and in the BSS 22 is assumed to include program instructions that, when executed by the associated DP 20A/22A, enable the device to operate in accordance with the exemplary embodiments of this invention, as was discussed above in detail. In these regards the exemplary embodiments of this invention may be implemented at least in part by computer software stored on the MEM 20B, 22B which is executable by the DP 20A/22A of the devices 20, 22; or by hardware, or by a combination of tangibly stored software and hardware (and tangibly stored firmware). Electronic devices implementing these aspects of the invention need not be the entire apparatus 20, 22, as shown, but exemplary embodiments may be implemented by one or more components of same such as the above described tangibly stored software, hardware, firmware and DP, or a system on a chip SOC or an application specific integrated circuit ASIC or a digital signal processor DSP.

In general, the various embodiments of the MS 20 can include, but are not limited to: data cards, USB dongles, cellular telephones; personal portable digital devices having wireless communication capabilities including but not limited to laptop/palmtop/tablet computers, digital cameras and music devices, Internet appliances, remotely operated robotic devices or machine-to-machine communication devices.

Various embodiments of the computer readable MEMs 20B/22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A/22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the GPRS/GERAN system, it should be appreciated that the exemplary embodiments of this invention are not limited for use with only this one particular type of wireless communication system, and that they may be used to advantage in other wireless communication systems such as for example E-UTRAN (also known as LTE/LTE-A) and others which use temporary identifiers for mobile stations which are not yet in an attached mode.

Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus comprising:
at least one processor and at least one memory storing a computer program;
in which the at least one memory with the computer program is configured with the at least one processor to cause the apparatus to at least:
select a core network from a broadcast list identifying multiple core networks; and
send an uplink message comprising a header and a body, the body comprising a data section and an identity section, in which the identity section comprises:
a temporary identifier for a mobile station,
a bit sequence indicating that a selected core network is identified in the uplink message and indicating type for the temporary identifier, and
an indication of the selected core network.

2. The apparatus according to claim 1, in which the bit sequence selects between a first type for the temporary identifier having a first length and a second type for the temporary identifier having a second length which extends over the first length into an extension field.

3. The apparatus according to claim 2, in which the temporary identifier is a temporary logical link identity TLLI, the first type is a random TLLI and the second type is a foreign TLLI.

4. The apparatus according to claim 3, in which the indication of the selected core network lies in a same octet as the extension field.

5. The apparatus according to claim 4, in which the foreign TLLI is derived from a packet temporary mobile subscriber identity PTMSI.

6. The apparatus according to claim 1, in which the apparatus comprises the mobile station operating in idle mode, and the uplink message comprises one or more segments of an ATTACH REQUEST or a ROUTING AREA UPDATE REQUEST.

7. The apparatus according to claim 6, in which the bit sequence indicates a first format which identifies a selected core network, and the at least one memory with the computer program is configured with the at least one processor to cause the apparatus further to translate bit positions between the first format and bit positions of a received message having a different format, such that bit positions of the first format carrying the temporary identifier for the mobile station correspond after the translating to different bit positions of the different format carrying the temporary identifier for the mobile station.

8. A method comprising:
selecting a core network from a broadcast list identifying multiple core networks; and
sending an uplink message comprising a header and a body, the body comprising a data section and an identity section, in which the identity section comprises:
a temporary identifier for a mobile station,
a bit sequence indicating that a selected core network is identified in the uplink message and indicating type for the temporary identifier, and
an indication of the selected core network.

9. The method according to claim 8, in which the bit sequence selects between a first type for the temporary identifier having a first length and a second type for the temporary identifier having a second length which extends over the first length into an extension field.

10. The method according to claim 9, in which the temporary identifier is a temporary logical link identity TLLI, the first type is a random TLLI and the second type is a foreign TLLI.

11. The method according to claim 10, in which the indication of the selected core network lies in a same octet as the extension field.

12. The method according to claim 11, in which the foreign TLLI is derived from a packet temporary mobile subscriber identity PTMSI.

13. The method according to claim 8, in which the method is executed by the mobile station which is operating in idle mode, and the uplink message comprises one or more segments of an ATTACH REQUEST or a ROUTING AREA UPDATE REQUEST.

14. The method according to claim 13, in which the bit sequence indicates a first format which identifies a selected core network, and the method further comprises translating bit positions between the first format and bit positions of a received message having a different format, such that bit positions of the first format carrying the temporary identifier for the mobile station correspond after the translating to different bit positions of the different format carrying the temporary identifier for the mobile station.

15. A computer readable memory tangibly storing a computer program executable by at least one processor, the computer program comprising:
code for selecting a core network from a broadcast list identifying multiple core networks; and
code for sending an uplink message comprising a header and a body, the body comprising a data section and an identity section, in which the identity section comprises:
a temporary identifier for a mobile station,
a bit sequence indicating that a selected core network is identified in the uplink message and indicating type for the temporary identifier, and
an indication of the selected core network.

16. The computer readable memory according to claim 15, in which the bit sequence selects between a first type for the temporary identifier having a first length and a second type for the temporary identifier having a second length which extends over the first length into an extension field.

17. The computer readable memory according to claim 16, in which the temporary identifier is a temporary logical link identity TLLI, the first type is a random TLLI and the second type is a foreign TLLI.

18. The computer readable memory according to claim 17, in which the indication of the selected core network lies in a same octet as the extension field.

19. The computer readable memory according to claim 18, in which the foreign TLLI is derived from a packet temporary mobile subscriber identity PTMSI.

20. The computer readable memory according to claim 15, in which the computer readable memory and the at least one processor are disposed within the mobile station operating in idle mode, and the uplink message comprises one or more segments of an ATTACH REQUEST or a ROUTING AREA UPDATE REQUEST.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
